(19) United States
(12) Patent Application Publication
(10) Pub. No.: US 2003/0205205 A1
(43) Pub. Date: Nov. 6, 2003

(54) Venting system for animal stall

(76) Inventor: William Opfel, Mesa, AZ (US)

Correspondence Address: Kenneth C. Booth, Schmeiser, Olsen & Watts LLP, 18 East University Drive, #101, Mesa, AZ, 85201, US

(21) Appl. No.: 10/411,435

(22) Filed: Apr. 9, 2003

Related U.S. Application Data
(63) Continuation-in-part of application No. 10/120,858, filed on Apr. 10, 2002.
(60) Provisional application No. 60/431,140, filed on Dec. 4, 2002.
(60) Provisional application No. 60/431,067, filed on Dec. 4, 2002.

(51) Int. Cl. A01K 1/015

(52) U.S. Cl. 119/526

(57) ABSTRACT

A venting system for an animal stall comprises a ventilation layer and an animal bedding layer. Stall flooring configurations comprising an animal bedding layer having moisture dissipating properties and a ventilation layer which circulates air through the animal bedding layer are most efficient. Additionally, a separation layer and/or an airflow dissipation layer may be included. By providing airflow through the animal bedding layer, moisture from the bedding is transferred to the air and carried away. Moisture within animal bedding encourages growth of bacteria, virus and other coliform pathogens and encourages decomposition. Specific ventilation layer examples include pipes buried in the ground and covered with gravel, clay support tiles, urethane and gravel mixture mats and finished surfaces. Perforations or porosity through the ventilation layer surface to the air passageways therein provide paths for airflow into or out of the ventilation layer.

### RELATED APPLICATION

This application is related to and claims priority to U.S. Provisional Patent Application to William Opfel, serial No. 60/431,140, titled “VENTING SYSTEM FOR ANIMAL STALL,” filed on Dec. 4, 2002, is related to and claims priority to U.S. Provisional Patent Application to William Opfel entitled “METHOD AND SYSTEMS FOR DISINFECTING ANIMAL LITTER AND STALLS”, serial No. 60/431,067, filed Dec. 4, 2002, and is a continuation-in-part application of U.S. Utility patent application to William Opfel, serial. No. 10/120,858, titled “ANIMAL LITTER AND METHODS OF FABRICATING SAME,” filed on Apr. 10, 2002, the disclosures of which are each hereby incorporated herein by reference.

### BACKGROUND OF THE INVENTION

1. Technical Field

This invention generally relates to a method and apparatus for venting an animal stall and more particularly to stall floor vent systems for animal bedding.

2. Background Art

Animal stalls, which come in all shapes and sizes, are confined areas used to house animals. One conventional and well known example of an animal stall is a horse stall. Animals often sleep as well as urinate and defecate in their stalls. Because of the animal waste produced in the stalls, the floors of the stalls are generally covered with a layer of animal bedding. Animal bedding, also called animal litter in some animal industries (collectively referred to herein as “bedding”), becomes moist from the animal waste deposited on it. Horse stalls are typically overwhelmed with as much as 15-30 gallons of urine and 10-50 pounds of manure per day, per animal. While much of the obvious solid animal waste can be removed directly from the bedding, the urine and other portions of the animal waste cannot.

Moist bedding cultivates the growth of many bacteria, fungus, salmonella, E. coli and other pathogens that are harmful to animals. The present solution to the problem of moisture is to remove the contaminated bedding and replace it with new bedding frequently. This also reduces ammonia emissions from urine-soaked bedding which is also harmful to animals. While this approach is effective, it can also be expensive to dispose of the contaminated bedding materials, and to use new bedding in the stall frequently. Typically, bedding materials are replaced daily, weekly or monthly to remove the contaminants. The replacement and disposal of 50-100 pounds or more of soiled bedding materials per stall can become a problem, especially since there are limited disposal options for urine- and manure-soaked bedding. Additionally, the costs of purchasing organic materials for animal bedding have increased as other industries compete for these organic materials. Also, conventional natural bedding materials are not reusable since use of built-up natural bedding leads to an increase in the populations of microbial pathogens in the bedding and excessive ammonia production. There is presently no known system available for rapidly removing the moisture within a stall without replacing the bedding.

Additionally, concerns such as odor, air quality, and ground and surface water quality implicates health related problems in both animals and humans. Aside from the private and public nuisance concerns, acute odors also indicate the potential for disease and respiratory problems. In humans, even low concentrations (100-300 parts per billion) of gases such as hydrogen sulfide are known to cause eye irritation, headaches, diarrhea, nausea, and an inability to sleep. Many of the gases, bacteria, viruses, spores, and worms found in manure contribute to a number of illnesses that may inhibit the full maturation of the animal and/or result in premature death of the animal. Animal manure often contains ammonia, hydrogen sulfide, methane, nitrates, trihalomethanes, spores of molds, and other contaminants. Moisture within the manure and surrounding environment enhances the potency of many of these contaminants. Odors resulting from high concentrations of animal manure and waste also significantly detract from the use, enjoyment, and value of surrounding property. This problem has been of particular concern in recent years and many approaches have been taken to overcome the moisture and associated odors associated with animal waste, particularly in manure pits.

### DISCLOSURE OF THE INVENTION

Embodiments of the present invention relate to venting systems for animal stalls including a venting layer and an animal bedding layer. Particular embodiments of the invention also include a separation layer and/or a diffusion layer. As used herein, the term “bedding” and “animal bedding” are considered to be interchangeable with the terms “litter” and “animal litter.” In the small animal industry, for example the poultry industry, the terms “litter” and “animal litter” are commonly used to refer to the material on which an animal urinates or defecates. In the large animal industry, and particularly in the horse industry, the convention is to use the terms bedding and animal bedding rather than litter and animal litter. Despite the difference in term usage in different industries, to simplify use for the purposes of this disclosure that relates to animal bedding and litter for animals of all sizes and types, the term “bedding” is intended to encompass “litter” and may be used interchangeably with “litter.”

In a first embodiment of the invention, a stall floor comprises a ventilation layer and a bedding layer. A pumping system pumps one or more gases (such as air) either into or out of the ventilation layer. The ventilation layer comprises a network of passages which release gas to or draw gas from the bedding layer. By gas passing through the bedding layer, the bedding layer dries more quickly. In particular embodiments, the ventilation layer may further comprise a diffusion layer and/or a separation layer. The diffusion layer, if used, disperses the flow of the gasses through the bedding layer so that the gasses pass by more surface area of the bedding. The separation layer, if used, maintains a separation between the bedding layer and lower-lying layers. The ventilation layer may be as simple as a network of perforated pipes running in parallel rows below the bedding layer, may include porous mats having passageways thereunder or there through for distributing the gasses, or may include more complex composite concrete-like porous flexible synthetic and aggregate mixtures through which the gasses pass. Particular embodiments of animal stalls of the present invention also include animal bedding materials having specific hardness, absorbency and wicking characteristics which maximize the rate at which moisture may be dissipated from the stalls.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1A is a plan view of an animal stall floor and ventilation system configured according to an embodiment of the present invention using a plurality of parallel ventilation pipes;

FIG. 1B is a plan view of an animal stall floor and ventilation system configured according to an embodiment of the present invention using a plurality of ventilation pipes in a grid pattern;

FIG. 2 is a cross-sectional view of a portion of an animal stall floor configured according to a first embodiment of the present invention;

FIG. 3 is a cross-sectional view of a portion of an animal stall floor configured according to a second embodiment of the present invention;

FIG. 4 is a cross-sectional view of a portion of an animal stall floor configured according to a third embodiment of the present invention;

FIG. 5A cross-sectional view of a portion of an animal stall floor configured according to a fourth embodiment of the present invention;

FIG. 5B is a bottom view of a ventilating floor mat configured according to an embodiment of the present invention;

FIG. 5C is a top view of the ventilating floor mat of FIG. 5B;

FIG. 6 is a cross-sectional view of a portion of an animal stall floor configured according to a fifth embodiment of the present invention;

FIG. 7 is a cut-away perspective view of a barn having a plurality of horse stalls each having a ventilated floor configured according to an embodiment of the invention;

FIG. 8 is a cross-sectional view of a portion of an animal stall floor configured according to an embodiment of the present invention having a support layer between two separation layers; and

FIG. 9 is a top view of the support layer shown in cross-section in FIG. 8.

### DETAILED DESCRIPTION OF EMBODIMENTS OF THE INVENTION

As discussed above, embodiments of the present invention relate to animal stalls and systems which increase the rate at which moisture is removed from animal bedding material in the stall. Conventional bedding materials for animals include such materials as, for example, natural organic materials, sand, clay, sand/clay mixtures, limestone dust, concrete, asphalt, rubber floor mats, volcanic cinders, baking soda, shredded paper, rubber pellets, zeolites, and potassium dichromate. The natural organic materials used as bedding materials include materials such as, for example, alfalfa, straw, saw dust, wood shavings, rice hulls, and grass. Animal bedding is used for animals of all sizes and types such as, for example, horses, cattle, sheep, pigs, cats, dogs, rabbits, hamsters, mice, guinea pigs, and the like.

While embodiments of the present invention are beneficial for all types of animal bedding used with all types of animals, examples and references herein may include specific references to horses and to specific type of animal bedding for convenience. It should be understood that these references are for convenience and example only and that those of ordinary skill in the art will readily understand how embodiments of the present invention apply to other types of animal bedding or animals.

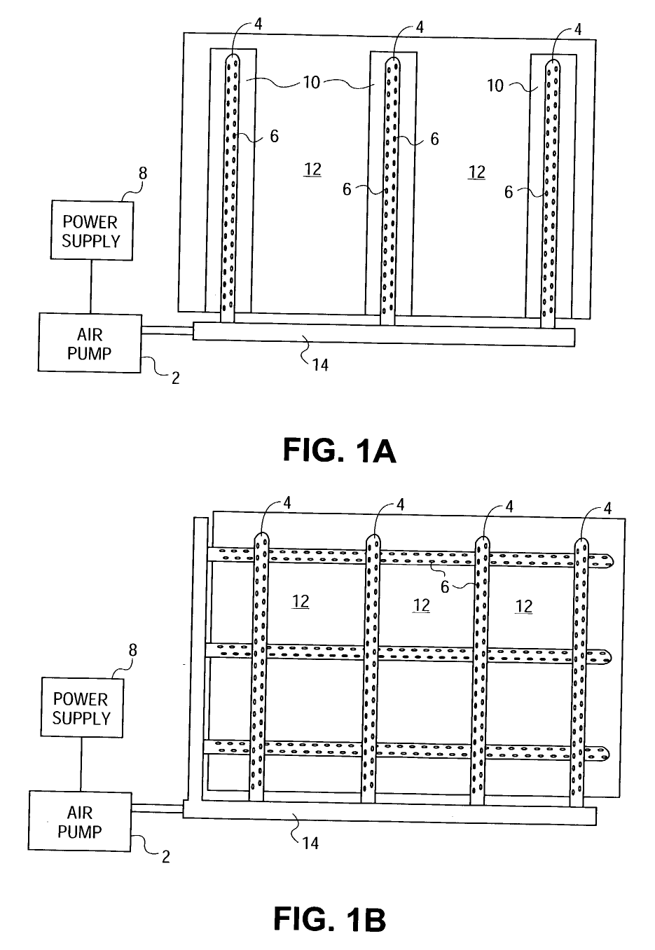

FIGS. 1A and 1B illustrate two examples of an embodiment of a venting system for an animal stall floor. Both FIGS. 1A and 1B include an air pump 2 pumping air, or some other gas, into a network of perforated pipes 4. The perforations 6 in the pipes 4 have a diameter of approximately ⅛ inch to ¼ inch. The precise dimensions of the perforations 6 and the pipes 4 are not crucial to the invention and would be engineered and configured to the specific installation need, humidity levels, climate, number and type of animals and the like. The perforations 6 may be drilled into the pipes 4, or the pipes may otherwise be made porous to allow air forced into the pipes 4 to be released at multiple locations along the pipes 4. The pipe rows and columns may be placed at any interval, but approximately an 18 inch spacing between pipes 4 has been found to work well for a stall having approximately ½ inch to 8 inches of kilned clay animal bedding granules placed thereon. The pipes may be formed of any material sufficient to form a passageway. Such materials may include, but are not limited to, clay, metal, polyvinylchloride (PVC), plastic, and the like. Materials that are non-corrosive and durable in the presence of animal waste and moisture are particularly useful. Clay materials, such as kilned clay pipes, are of particular interest because they are inexpensive, durable, and non-toxic. PVC is also very useful because of its durability, cost, availability and ease of installation. The precise size of the pipes used is not crucial to operation of the system, and the specific size used will depend upon the environment of the system and the characteristics of the other related system components such as the air pump. It is expected that pipe dimensions will range between a diameter of approximately 1 inch to 6 inches. More particularly, for a 12 foot by 12 foot horse stall, it has been found that a 4 inch diameter pipe works well with an animal bedding thickness of between ½ inch to 8 inches, and provides sufficient air flow to efficiently remove moisture and noxious gases from the stall with a cost efficient air pump.

A power supply 8 provides power to the air pump 2. The power supply 8 may be any electrical source, such as a conventional alternating current (AC) 110 V or 220 V outlet or, where desirable, a solar powered electrical source. Because animal bedding may be used in areas where electrical power is not readily available, or in areas where pollution or other conservation measures are of concern, it is contemplated that solar power may be a significant source of power for embodiments of the invention. For all of the embodiments of the present invention, the air pump 2 may be configured to force air into the ventilation network, or may be configured to draw air from the ventilation network, thereby causing air to be drawn into the network through the pipe perforations 6. What is particularly important to the present invention is that a flow of air is created through the animal bedding rather than just over the top of the animal bedding. The air pump size and volume of air pumped by the air pump 2 depends upon many factors and may be readily determined by one of ordinary skill in the art for the specific stall and animal bedding configuration used. Some relevant factors include the dimensions of the ventilation layer components, the type of animal bedding and/or dispersion material used, the depth of the animal bedding and/or dispersion layer applied, the dimension of the stall used, whether a separation layer is used, and the amount of moisture to be dispersed.

For embodiments where air is pumped into the ventilation layer for the stall, the air may be heated to cause warm air circulation through the stall rather than cold air. This increases the comfort of the animals in the stall in cold regions and increases the quantity of moisture that may be removed from the stall. Additionally, for regions where extremely cold temperatures cause freezing of the moisture among the bedding materials, the warm air helps to melt the moisture to allow removal.

As indicated by the differences between FIGS. 1A and 1B, embodiments of the invention involving a pipe network may include pipe trenches 10 dug or cut into the ground 12 (see FIG. 1A), or the network may be placed on top of the ground 12 (see FIG. 1B). The ground 12 may be any floor layer conventionally found within an animal stall such as a floor made of, for example, dirt, rock, wood, concrete, asphalt, and the like. Additionally, a dirt floor may also be made more stable or otherwise sealed by first mixing a polymer or other tacifier with the surface to form a stable and/or sealed top layer of dirt before applying the additional layers of the system. This may be done by mixing a dry or moist tacifier with the top layer of soil to form a homogeneous mixture, adding additional moisture if needed, and allowing the top layer to harden. Alternatively, it may be done by applying the tacifier as an aqueous solution to the top layer. Appropriate tacifiers are distributed by Earthcare Consultants, LLC of Arizona. Use of a tacifier to create an adhered top layer of dirt before applying ventilation or other layers of the system will also reduce contamination of the animal bedding from the underlying dirt. Creating a tacified top layer provides results similar to, but much less expensive than, placing a layer of concrete or urethane in the stall to cover the ground layer. A ventilation manifold 14 that supplies air to or collects air from the plurality of pipes 4 may also be included for more uniform distribution or collection of air. Any configuration and arrangement of pipes is suitable for embodiments of the present invention so long as it provides ventilation that allows an air stream to pass through the animal bedding layer.

For embodiments where the air pump 2 is configured to pump air into the ventilation network, the air passing through the bedding becomes moist and lifts some of the moisture from the bedding into the ambient air within the stall. Other ventilation may be used to further remove the moist air from the stall. For embodiments where the air pump 2 is configured to pump air from the ventilation network, the air passing through the bedding becomes moist and the pump draws the moist air from the stall through the pipes 4 and vents the air outside. Either way, dry air passing through the bedding causes the bedding to dry faster than without the air.

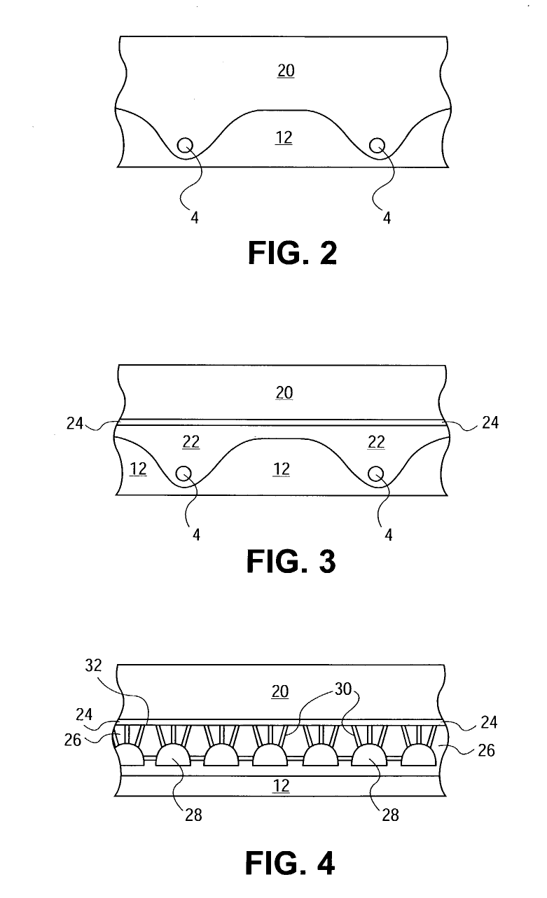

As shown in FIG. 2, a layer of bedding 20 may be placed directly on the ventilation layer 4 and ground 12. To an extent dependent upon the bedding material used, as the air passes through the bedding layer 20, the bedding layer 20 disperses the air so that it contacts more bedding material. As shown in FIG. 3, however, an additional dispersion layer 22 may be added beneath the bedding layer 20 to increase the dispersing of the airflow paths among the bedding and, thus, the quantity of bedding which is in contact with an air stream. The dispersion layer 22 is formed of a small granular material such as pea gravel or the like which will create a large plurality of divergent or otherwise convoluted air flow paths through the dispersion layer 22, thus increasing the quantity of bedding materials which come in contact with the air flow. For bedding materials made of small granular materials, such as the kilned clay bedding manufactured by Equidry Bedding Products, LLC of Arizona, the dispersion layer 22 may alternatively be formed of bedding material.

An optional separation layer 24 may be included between the dispersion layer and the bedding layer to keep the materials separate. The separation layer 24 also keeps dirt and other large contaminants in the ground layer from contaminating the bedding, and keeps other contaminants such as feed, animal hair and dander, animal feces, bugs, and the like within the animal bedding layer. Additionally, the separation layer 24 helps to further disperse the air flow paths preventing rapid straight flow of air through the bedding material. The separation layer 24 includes a mesh, membrane or other material which can pass fluids such as gasses and moisture, but restricts passage of larger contaminants. Ideally, the separation layer 24 material is durable, non-absorptive, non-biodegradable, and it is contemplated that most embodiments of the separation layer 24 material will also be flexible.

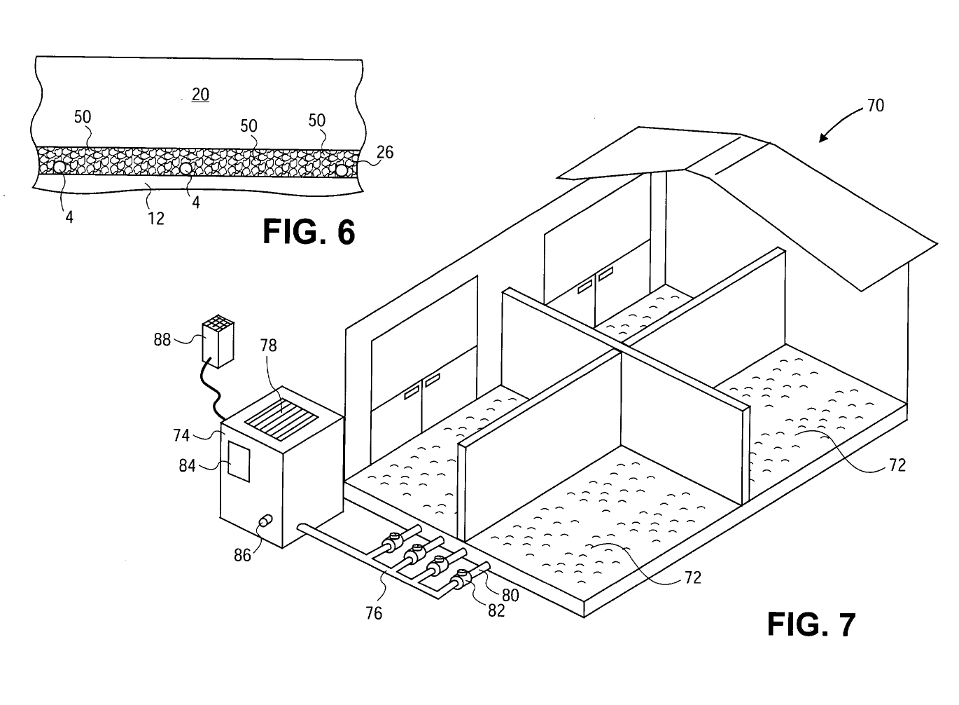

Examples of separation layer 24 materials include, but are not limited to, woven and non-woven geotextile materials such as that sold by TC Mirafi having a North American contact office in Pendergrass, Ga. The Mirafi® Filterweave is a woven geotextile comprised of ultraviolet stabilized monofilament polypropylene yarns. The Mirafi® Filterweave is durable and acts to turn the air sideways so that air moves both vertically and horizontally within the bedding layer. Other materials appropriate for use as a mesh or otherwise configured separation layer include, but are not limited to, urethane, polyester, rubber, plastic, and a mix of aggregate with another moldable material to form a porous layer such as that described with reference to FIG. 6. When a material with a plurality of small openings, such as a meshed material, is used as the separation layer 24, the separation layer also acts as a dispersion layer 24 by preventing rapid straight flow “short circuiting” of air to the bedding surface. For example, the Mirafi® Filterweave material acts to turn the air sideways so that the air moves both vertically and horizontally through the pours, further dispersing the air into the bedding layer 20.

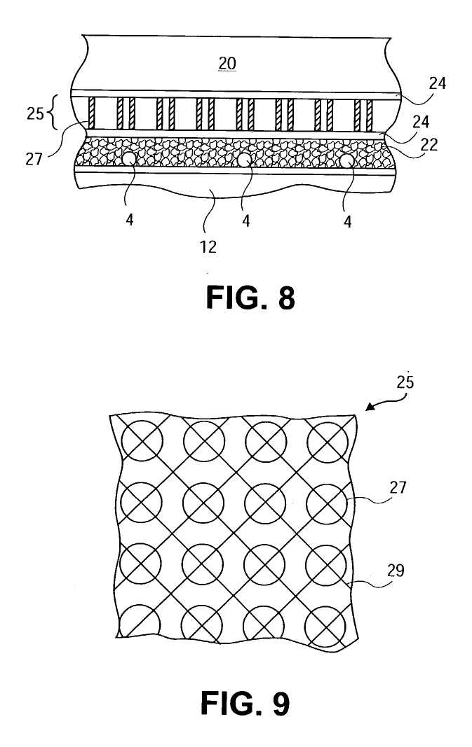

FIG. 8 illustrates another example of a combined separation layer and dispersion layer. Like other embodiments of the present invention, the ventilation system illustrated in FIG. 8 includes a ventilation layer 4 on the ground 12 and first dispersion layer 22 over the ventilation layer 4. The material used for the first dispersion layer for this example is less pertinent than in other examples and embodiments because a second dispersion layer is used, but like the other embodiments and examples, a small granular material works well. A second dispersion layer comprising first and second separation layers 24 on either side of a support layer 25. The first and second separation layers 24 of this particular examples are a durable, meshed, geotextile material. In other particular examples, the mesh material 24 is only used on one side of the support layer. The support layer 25 may be formed of any material which has sufficient strength to maintain an air gap between the mesh materials under the weight of the animal bedding layer 20 and animal walking on the animal bedding. Creation of an air gap between the bedding layer and the ventilation layer further enhances the moisture transfer properties of the materials used for the bedding layer 20, and may significantly reduce the time necessary to dissipate the moisture. One example of a support material suitable for use as a support layer 25 is the Gravelpave structure manufactured and distributed by Invisible Structures, Inc. of Golden, Colo.. As shown with reference to FIGS. 8 and 9, the support layer 25 includes a plurality of rigid support structures 27, such as rigid cylinders, which maintain the gap between the separation mesh layers 24. As shown in FIG. 9, the support structures 27 are attached for ease of use, storage and installation by connectors 29. These support structures 27 and connectors 29 may be formed of any material, but hardened plastic, PVC, or other like material. The connectors 29 enable the support structures to flex and even roll for storage. The separation layers 24 may be merely laid over and under the support layer 25 during installation, or may otherwise be coupled to the support layer 25, such as by heat welding, ties, or other method known in the art.

FIG. 4 illustrates a third embodiment of the invention which includes a concrete floor used as the ground layer 12, a separation and dispersion layer 24 formed of a geotextile material, a layer of animal bedding 20 and a ventilation layer 26 forming an elevated surface 32 having chambers 28 there through with a plurality of perforations 30 extending from the ventilating chambers 28 to the elevated surface 32. The ventilation layer 26 creating the elevated surface 32 may be formed of any material which creates the elevated surface 32 and chambers 28. For example, the ventilation layer 26 may be formed of concrete, kilned clay, brick, stainless steel or other metal, plastic, rubber, urethane, epoxy, and the like. The ventilation layer 26 should be strong enough to support the weight of the animal in the stall, and is preferably non-corrosive and resistant to degradation when exposed to animal waste and any gasses which are passed through the ventilation layer 26.

One particular example of a suitable ventilation layer 26 forming an elevated surface 32 with ventilating chambers 28 and perforations 30 is a ventilation layer 26 formed of filter blocks such as those distributed by Mission CP having a distribution center in El Paso, Tex. which are manufactured and used for trickling filters in wastewater treatment plants. The Mission CP filter blocks include a plurality of interconnecting blocks, each including hollow chambers which, when interconnected, permit air to be flowed there through. Each chamber also includes a plurality of perforations that allow air to escape from an upper surface of the block. For use with large animals such as horses and cattle, the Mission CP filter blocks currently sold will likely need to be redesigned with either a shorter profile or thicker walls to support the weight of the animal. Those of ordinary skill in the art of materials strengths will be able to create a ventilation layer 26 having appropriate dimensions and strengths depending upon the specific material used.

The optional separation layer 24, which is also a dispersion layer 24, like its use in other embodiments of the present invention, helps to keep contaminants other than moisture from the animal bedding layer 20 from entering the ventilation layer 26. Not only does this enable easier cleaning of the animal bedding layer 20, such as through a vacuum cleaning system or other method, but it helps to prevent contaminants from becoming lodged in the perforations 30 of the ventilation layer 26. The dispersion layer 24 also helps to better disperse airflow through the animal bedding layer 20, further enhancing evaporation of moisture from the overall system.

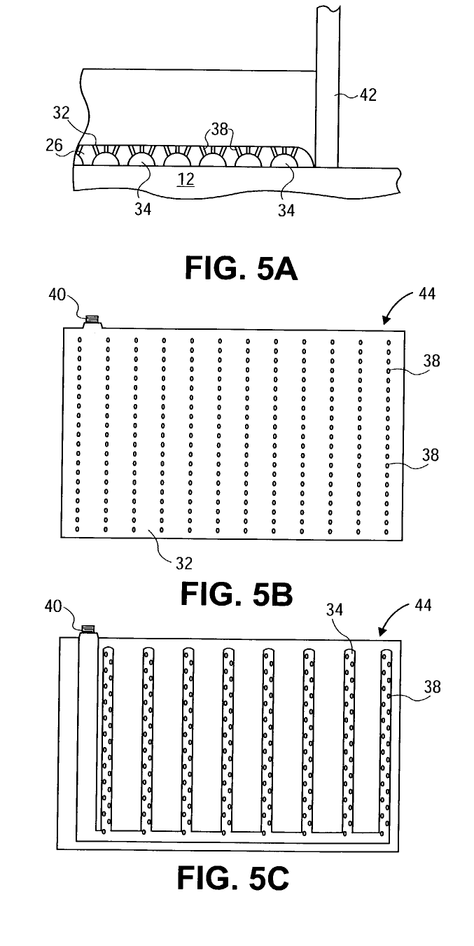

FIGS. 5A, 5B and 5C illustrate a fourth embodiment of a ventilation system for an animal stall for use with embodiments of the present invention. This fourth embodiment includes a ventilation layer 26 which, like the third embodiment shown in FIG. 4, creates an elevated surface 32 under which air may pass. The fourth embodiment, however, rather than having ventilating chambers, includes ventilating channels 34 in a bottom surface thereof. Perforations 38 allow air to pass between the elevated surface and the ventilating channels 34. FIG. 5A is a cross-section of an animal stall including a ground layer 12 formed of concrete, an animal bedding layer 20, walls of the animal stall 42, and a ventilation layer 26 formed as a mat 44. The mat includes channels 34 in its bottom side (FIG. 5C) and a plurality of perforations 38 which extend from the channels 34 to the elevated surface 32 of the mat 44 (FIG. 5B). A coupling 40 may also be included for coupling to an air hose to assist in pumping gas into or out of the channels 34 of the mat 44. When the mat 44 is placed on the ground layer 12 of an animal stall 42 and covered with an animal bedding layer 20, the weight of the materials over the ventilating channels 34 create at least a partial seal between the mat 44 and the ground layer 12 sufficient to draw air into or blow air or another gas out of the perforations 38 to cause air flow through the animal bedding 20.

The mat 44, like the ventilation layer 26 of the embodiment shown in FIG. 4, may be formed of many kinds of materials such as, for example and without limitation, concrete, kilned clay, brick, stainless steel or other metal, plastic, rubber, urethane, epoxy, and the like. Also like the embodiment shown in FIG. 4, depending upon the material used smaller interconnecting sections may be desirable to allow the mat 44 to be more manageable for installation into a large animal stall. Alternatively, a plurality of interconnecting mats 44 may be used. Summit Flexible Products of Buckner, Ky. manufactures interlocking stall flooring kits, the interlocking systems of which could be applied to the present invention to enable interlocking of the mats 44 of the present embodiment. While embodiments of the invention illustrate use of a mat on a concrete floor, it is contemplated that the mats will also be just as applicable for use on a dirt or wood floor, or floors made of other materials.

In one particular embodiment of the invention, the mat 44 is formed of a urethane molded to include channels 34 and perforations 38. Alternatively, the perforations 38 may be drilled after the channels 34 are molded and/or the channels may be cut or etched into the mat using conventional methods known in the art. Urethane works particularly well as a material for a ventilation layer 26 because it is extremely durable, strong, resistant to degradation, non-corrosive, cost-efficient, and can be molded into any shape or size needed. MCP Urethanes of Pittsburg, Kans. produces urethane mats and coatings for sporting floors that may be readily adapted for use with embodiments of the present invention. As should be clear from comparison of the embodiments shown in FIGS. 5 and 6, urethane may be molded into a mat or mat sections and placed in the stall, or may be applied directly into the stall as a layer above the existing ground layer 12.

In one particular embodiment of the invention using a layer of urethane, for example, the floor of the stall is trimmed out into a basin shape with approximately 4 inch walls and a downward slope to the center of the floor with a sump in the middle. This basin shape would thereby be trimmed into native soils underlying the stall. This excavation, in principle, would resemble a pool excavation. Much like the embodiment shown and described with reference to FIG. 6, air vent plumbing is placed in the excavated space and urethane or another durable material is poured and trowled into the excavated basin until a desired wall and floor thickness is achieved. Holes are then drilled periodically through the durable material to penetrate the air vent plumbing. Animal bedding is disposed over this surface within the stall. This method of forming a stall flooring results in a very tight, permanent, soil-sealed basin capable of holding and ventilating animal bedding to enhance its drying.

FIG. 6 illustrates a fifth embodiment of the present invention comprising a ventilation layer 26 having a network of ventilating pipes 4, such as the pipes shown in FIGS. 1A and 1B and described in reference thereto, and a resilient, supportive material 50 surrounding the pipes. By mixing a quantity of small aggregate material, such as crushed rock or gravel, with a flexible synthetic material, such as urethane, epoxy, resin, polyurethane, polyethelene, polypropylene and the like, a mat or other layer may be formed which provides support sufficient to protect pipes below or embedded in the ventilation layer from the weight of an animal in the stall. By creating a mix that is between approximately 50-75% aggregate and only approximately 25-50% synthetic material, the aggregate is of a density that point-to-point contact between the aggregate materials creates support for even heavy weights placed upon it. The flexible synthetic material allows the ventilation layer material some flexibility and resiliency for comfort.

The layer of material may be molded into a mat, such as that shown and described with reference to FIG. 5, may be molded into a mat encompassing a pipe network, or may be laid and cured in an animal stall on top of a pipe network much like cement to a thickness of between about 1 inch to 4 inches. The specific proportion of aggregate versus synthetic material in the mix depends upon the weight that needs to be supported by the layer. Those of ordinary skill in the art will readily be able to determine the appropriate mix for a given ventilation layer 26 depending upon the thickness of the layer, the use for the animal stall, and the point weight that needs to be supported. As explained previously, urethane is a very useful material for use in an animal stall because of its durability and chemical properties.

To allow the ventilation layer 26 to ventilate, perforations may be drilled or punched through the synthetic and aggregate mixture to the perforated ventilating pipes 4. Alternatively, the mix of aggregate and synthetic material may be air entrained to create a porous material much like pumice stone. Conventionally, flexible synthetic materials, such as urethane, are used to create a seal or barrier between two regions. It is considered a mistake if a urethane layer, such as that used in a urethane mat or floor, is porous because a porous layer does not serve its conventional purpose. However, for the ventilating layer 26 of the present embodiment of the invention, it is desirous that the layer be porous. By air-entraining the mixture so that the layer includes air passages, contrary to conventional practice, ventilating air to or from the ventilating network of pipes 4 within the layer may be circulated through the bedding material and will be diffused by the aggregate within the mixture.

The embodiments of FIGS. 4-6 are particularly useful where a flooring material exists in an animal stall but a ventilation system is still desired without damaging or disturbing the existing ground layer. For either the embodiment shown in FIG. 4 or 5, or for removable mat versions of the embodiment shown in FIG. 6, the ventilating layer 26 may be formed in interconnecting sections that are installed to create a continuous ventilation space beneath the layer of animal bedding 20 for ease of installation.

FIG. 7 is a cut-away view of a barn 70 including a plurality of horse stalls each configured according to a ventilation system embodiment of the present invention. While the embodiment described with reference to FIG. 7 is configured to pump gasses into the ventilating layers for each stall for the exemplary purposes of this embodiment, it may alternatively be configured to pump air out of each stall through the animal bedding 72. Outside the barn 70, a pump 74 is coupled to a manifold 76 which pumps air from the horse stall through a ventilation layer in the horse stall, through a ventilation pipe 80 coupled to the manifold 76 and releases the air through an air vent. Additional air filtering as is known in the art may also be applied to remove contaminants from the air before releasing them to the environment. For example, bio filters may be used to clean the air and remove harmful or undesirable gases from the air before release (such as ammonia and hydrogen sulfide). By merely creating either a positive or a negative air pressure within the barn 70, animal generated gaseous environmental contaminants can be cycled out of the barn 70, thereby increasing the cleanliness of the barn environment. The pump 74, a controller 84 and control valves 82 are powered either by conventional AC power supplies or by a solar energy collector 88. Solar energy collectors are known in the art and conventionally include a plurality of photovoltaic cells for generating electrical energy from sunlight.

A control valve 82 on each ventilation pipe 80 manages control of into which ventilation pipe 80 the air from the pump 74 is pumped. The control valves 82 and pump 74 are controlled through a controller 84 which determines when and for how long the pump 74 remains on, and which control valve or valves 82 are open. The controller 84 may be configured as a simple mechanical timer which automatically activates the pump 74 and each control valve 82 sequentially for a periodic cycle, or may be configured as a more complex digital controller which controls merely the timing, or even includes sensors within the stalls for monitoring temperature, moisture levels, and the like, for activating the pump 74 and a particular control valve 82 when a particular horse stall needs appropriate air ventilation. The controller 84 could also be configured to control the volume at which the pump 74 pumps air into or out of the stalls. Ventilation may, of course, be run constantly if desired for a particular application, but it is anticipated that most applications will only require periodic ventilation to assist in removal of the moisture from the animal bedding. How much ventilation is needed will, of course, depend upon the bedding material used, the humidity levels for the region, the quantity of liquid waste produced by the animal, the rate of air flow through the animal bedding, how well the air flow contacts the animal bedding, as well as a number of other factors that will be evident to those of ordinary skill in the art.

As explained previously with reference to FIGS. 1A and 1B, particular embodiments of the invention also include a heating coil for pumping heated air into each horse stall. In regions where extremely cold temperatures are common and moisture from animal waste, rain, or even just humidity is a concern, the combination of the moisture and cold temperatures often causes ice to form on the floor of animal stalls. The moisture freezing makes replacement and cleaning of bedding material very difficult, and can be a source of injury to the animal. To overcome the problems associated with ice forming in the stall, heated air may be blown through the ventilation system and animal bedding to the stall. In addition to the ventilation increasing the rate at which the moisture dissipates, the heated air melts the ice, thus removing the danger to the horse. In areas where extreme cold exists and heated barns are used, controlled pressurized ventilation of stall air to outside of the barn could limit losses of heated air to a minimum while removing noxious gaseous contamination in barn bedding.

In addition to pumping ambient air through the ventilation system into a stall, other gasses may be pumped through the ventilation system. For this purpose, an external gas coupling 86 may be associated with the pump 74. It is contemplated that other gasses may be used in the ventilation system for purposes other than removing moisture. For example, disinfectants, ozone, atomized phenols, nitrogen, carbon dioxide, fly control compounds, or even air fresheners may be added to or replace the flow of ambient air into the system. As should be clear from the disclosure herein, depending upon the gas or other material flowed into the animal stall, the animal may need to be removed from the barn before the material is pumped and for a time thereafter to prevent injury to the animal. In a particular embodiment, the system is configured for pumping steam into the animal stall to assist in disinfecting the animal bedding. For examples of alternative fluids for placing in the venting system and methods of disinfecting animal stalls, refer to co-pending patent application Ser. No. ______, to William Opfel titled “METHOD AND SYSTEMS FOR DISINFECTING ANIMAL LITTER AND STALLS” assigned to the same assignee as the present application and filed simultaneous herewith, the disclosure of which is hereby incorporated herein by reference. Contaminants should be removed prior to disinfecting. While contaminants do not necessarily have to be removed from the bedding prior to disinfecting, removal of the contaminants will allow the stall and bedding to be more effectively and/or efficiently disinfected. Moreover, some disinfectants may be inactivated in the presence or organic contaminants, and therefore, they would need to be removed from the stall and bedding prior to disinfecting.

Ventilation Example: A 14 foot×18 foot horse stall was prepared with a venting system by digging trenches approximately 4 inches deep and 3 inches wide spaced at 18 inch intervals across the dirt floor. Two-inch PVC pipe was installed into each of the trenches and coupled to a common manifold that was coupled to an air pump capable of pumping air into the ventilating pipes a rate of 30 cubic feet per minute or more. The trenches were filled with a dispersion layer comprising a small, granular, kilned clay bedding material distributed by Equidry Bedding Products of Arizona. A mesh membrane was placed over the dispersion layer; the mesh membrane comprising a thin geotextile material. Approximately 4 inches to approximately 8 inches of horse bedding distributed by Equidry Bedding Products of Arizona was placed on top of the mesh membrane. The stall was then saturated with approximately 200 gallons of water and left with the ventilation system running. Within 4 hours, there was no noticeable moisture in the stall. Within 12 hours, there was no measurable moisture within the stall as measured by humidity gauges. Because an average horse produces approximately 20 to 30 gallons of urine per day, the moisture dissipating capacity of this example would be more than adequate.

The kilned clay bedding materials produced by Equidry Bedding Products of Arizona are particularly useful with embodiments of the present invention for their ability to quickly dissipate water to their surroundings. The Equidry kilned clay bedding materials are also extremely durable compared with other clay bedding products, and are reusable. It should be noted that many conventional animal bedding products become crushed under the hooves of large animals, such as horses, and become degraded by use over time. The horse bedding products available through Equidry Bedding Products, LLC of Arizona (“Equidry”), which are described in U.S. Utility patent application Ser. No. 10/120,858, titled “ANIMAL LITTER AND METHODS OF FABRICATING SAME,” filed on Apr. 10, 2002 and assigned to the same assignee as the present application, the disclosure of which was previously incorporated herein by reference, typically have a rocklike quality with a hardness rating based upon a LA Abrasion test value of less than 40 (and more particularly less than 30) using modified mesh sizes for the smaller granule size of horse bedding, and are sufficiently hard to withstand horse trampling and other mechanically and chemically abrasive cleaning processes. Increasing hardness for animal bedding, however, may significantly reduce the absorptive capacity and rate of the animal bedding in undesirable ways. Those of ordinary skill in the art will understand the benefits and trade-off of hardness and absorbency in animal bedding.

Particularly useful animal bedding materials for use with the present invention are those having an absorption capacity of approximately 0.5 ml/g to approximately 2.5 ml/g, or more specifically approximately 1.4 ml/g to approximately 1.9 ml/g. High absorbency is achieved as a result of porosity enhancing techniques and the resulting microporosity and macroporosity of the animal bedding granules. The combination of external surface area and internal porosity surface areas can lead to very large lab-calculated surface areas. Animal bedding compositions particularly useful with the invention may have a surface area of approximately 2,000,000 ft²/ft³ to approximately 40,000,000 ft²/ft³, or even up to approximately 75,000,000 ft²/ft³ if acid activated or bloated by kilning. Approximate examples of surface areas of gravel, sand, diatomaceous earth, and Equidry animal bedding are illustrated in the following table for comparison:

| | | Diatomaceous | Equidry |
|---|---|---|---|
| Gravel | Sand | Earth | Animal Bedding |
| 600 ft²/ft³ | 1500 ft²/ft³ | 200,000 ft²/ft³ | 2,000,000-75,000,000 |
| | | | ft²/ft³ |

An absorbency rate is a measure of the speed of movement of water (water front) as it is absorbed into a material. A wicking test was performed on two samples of Equidry animal bedding by allowing water from a water bath to climb the animal bedding composition in a standard, plastic, 52 mm inside diameter, 500 ml, graduated PolyLab™ cylinder, or column as is known in the art. Water enters the column through perforations in the base of the column. The perforations are of sufficient size and number to allow water from the bath to enter in the column, but not allow material to fall into the water bath. The wetting front in the material rises over time and is then plotted as distance versus time. A first animal bedding sample having granule sizes ranging from between 8 mesh to 20 mesh had an absorbency rate of approximately 90 milliliters or more within 10 minutes. A second animal bedding sample having granule sizes ranging from between 20 mesh to 50 mesh had an absorbency rate of approximately 105 milliliters or more within 90 seconds.

Accordingly, animal bedding with superior absorbency and wicking, and sufficient hardness to not become significantly degraded in use or during cleaning are most desirable for use with embodiments of the present invention. If the animal bedding is too soft, it will become broken and turned to powder from the horse's activities within the stall or from mechanical agitation that may occur during transportation or cleaning of the animal bedding. If the animal bedding lacks absorption capacity or absorbs too slowly, it is less useful as animal bedding. Also particularly useful is animal bedding which quickly releases absorbed moisture through evaporation or rapid evaporation to dissipate moisture levels and fractionate off a large portion of absorbed ammonia in solution with the moisture.

For the exemplary purposes of this disclosure, use of Equidry™ animal bedding in accordance with ventilation system embodiments of the invention provides many advantages over conventional animal beddings. Equidry™ granules have high hardness coupled with high absorbency, thereby rendering the bedding, dust and odor free, easy to clean, disinfect, and maintain, inexpensive, and long lasting, durable, and reusable in contrast to conventional beddings. Additionally, Equidry™ animal bedding effectively and efficiently absorbs and desiccates the waste deposited by the animal over time. The absorption of moisture from the fecal waste leaves it desiccated so that it is not as offensive in odor production as its moist counterpart. Over time, absorbed moisture and ammonia are dissipated from the surface and porous structures of Equidry™ granules with the result that moisture/odor is controlled along with a corresponding reduction in fly and other bug problems. The ventilation affects a reduction in odor, dust, flies, and relative humidity thereby inhibiting the primary disease causing factors. Therefore, Equidry™ reduces wet spots in the stall, and in doing so chemically ties up or partitions off the bulk of ammonia in the animal's wastes leaving a clean, dry, healthy, and relatively odor free stall environment.

By additionally ventilating the stall environment as described with reference to the many embodiments and examples provided herein, dissipation of the moisture from the stall to the environment is significantly enhanced, further reducing the potential negative health effects on the animal caused by moisture in the stall. The various embodiments of the invention described herein are particularly useful in maintaining animal stalls due to the rapid mode by which moisture is absorbed to reduce pooling of urine and composting of manure, and evaporated to the environment. Embodiments of the invention prolong the usefulness of whatever animal bedding is used, promote a more healthy environment for the animal, and reduce the overall maintenance and health care costs for the animal.

Applicant has found that an animal stall comprising a system such as that described herein in combination with an animal bedding layer formed of animal bedding having the hardness, absorptive and wicking properties as further described, creates an optimal stall environment for rapid dissipation of moisture. Rapid dissipation of moisture in an animal stall significantly reduces the existence of moisture-reliant bacteria, viruses, fungus, and the like, thereby significantly increasing the health of the animal housed therein and the people who care for the animals. In many cases, the moisture is dissipated before any significant amount of manure composting occurs. Manure composting is undesirable within an animal stall because composting produces ammonia, hydrogen sulfide and other decomposition gasses that are terrible to smell and can be harmful to the animals. Providing for an increased aeration promotes aerobic conditions that are preferred over anaerobic high odiferous conditions.

The embodiments and examples set forth herein were presented to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A ventilation system for an animal stall, the system comprising:
a ventilation layer comprising a plurality of passageways configured to carry a flow of air;
a pump coupled to at least one of the passageways;
an animal bedding layer above the ventilation layer, the animal bedding layer comprising animal bedding materials; and
a separation layer between the ventilation layer and the animal bedding layer, the separation layer comprising a substantially planar layer having a plurality of openings therethrough, the openings being smaller than the animal bedding materials but large enough for air to pass through.

2. The ventilation system of claim 1, wherein the ventilation layer comprises a plurality of interconnected and perforated pipes.

3. The ventilation system of claim 1, wherein the ventilation layer comprises an elevated surface having a plurality of interconnected chambers thereunder, the elevated surface comprising a plurality of perforations extending through the surface to the plurality of chambers.

4. The ventilation system of claim 1, wherein the ventilation layer comprises an elevated surface having a plurality of interconnected channels thereunder, the elevated surface comprising a plurality of perforations extending through the surface to the plurality of channels.

5. The ventilation system of claim 1, wherein the ventilation layer comprises a plurality of interconnected and perforated pipes extending through a porous flooring surface.

6. The ventilation system of claim 5, wherein the porous flooring surface comprises a flexible synthetic material.

7. The ventilation system of claim 6, wherein the porous flooring surface further comprises approximately 50% or more aggregate material.

8. The ventilation system of claim 6, wherein the flexible synthetic material is at least one of urethane, epoxy and polyethelene.

9. The ventilation system of claim 1, wherein the ventilation layer comprises a removable mat.

10. The ventilation system of claim 1, wherein the pump is configured to draw air from the ventilation layer.

11. The ventilation system of claim 1, wherein the pump is configured to force air into the ventilation layer.

12. The ventilation system of claim 1, further comprising a dispersion layer between the ventilation layer and the separation layer.

13. The ventilation system of claim 1, wherein the dispersion layer comprises a small granular material.

14. The ventilation system of claim 1, wherein the separation layer comprises a geotextile layer.

15. The ventilation system of claim 1, wherein the separation layer comprises a non-absorptive, non-biodegradable, mesh layer.

16. The ventilation system of claim 1, wherein the separation layer comprises two separation layers having a support layer therebetween, the support layer being substantially rigid and maintaining a space between the separation layers.

17. The ventilation system of claim 1, wherein the animal bedding layer comprises an organic bedding material.

18. The ventilation system of claim 1, wherein the animal bedding layer comprises an inorganic bedding material.

19. The ventilation system of claim 1, wherein the animal bedding layer comprises a granular bedding material.

20. The ventilation system of claim 19, wherein the granular bedding material comprises granules each having at least 3% by weight of calcium bentonite clay and at least 3% by weight of at least one of illite clay and kaolinite clay.

21. The ventilation system of claim 19, wherein the granular bedding material comprises granules having a density of between approximately 20 lb/ft³ and approximately 70 lb/ft³.

22. The ventilation system of claim 19, wherein the granular bedding material comprises granules having an LA Abrasion hardness value of less than approximately 40.

23. The ventilation system of claim 19, wherein the granular bedding material comprises granules having an absorption capacity of approximately 0.5 ml/g to approximately 2.5 ml/g.

24. The ventilation system of claim 19, wherein the granular bedding material comprises granules having an absorption capacity of approximately 1.4 ml/g to approximately 1.9 ml/g.

25. The ventilation system of claim 19, wherein the granular bedding material comprises granules having an absorption rate in a 52 mm diameter column of approximately 90 milliliters or more within 10 minutes.

26. The ventilation system of claim 19, wherein the granular bedding material comprises granules having a surface area greater than approximately 2,000,000 ft²/ft³.

27. The ventilation system of claim 19, wherein the granular bedding material comprises granules having a size between approximately 4 mesh to approximately 50 mesh.

28. The ventilation system of claim 1, further comprising at least two separate ventilation layers for at least two separate animal stalls, the at least two separate ventilation layers each coupled to a controller configured to selectively connect and disconnect the respective ventilation layer to air flow generated through the pump.

29. The ventilation system of claim 1, further comprising a solar collector configured to collect solar energy to operate the pump.

30. A ventilation system for an animal stall, the ventilation system comprising:
a ventilation layer comprising a plurality of passageways configured for carrying a flow of air;
a pump coupled to at least one of the plurality of passageways; and
an animal bedding layer above the ventilation layer, the animal bedding layer comprising granular animal bedding materials each having at least 3% by weight of calcium bentonite clay and at least 3% by weight of at least one of illite clay and kaolinite clay.

31. The ventilation system of claim 30, wherein the ventilation layer comprises a plurality of interconnected and perforated pipes.

32. The ventilation system of claim 30, wherein the ventilation layer comprises an elevated surface having a plurality of interconnected chambers thereunder, the elevated surface comprising a plurality of perforations extending through the surface to the plurality of chambers.

33. The ventilation system of claim 30, wherein the ventilation layer comprises an elevated surface having a plurality of interconnected channels thereunder, the elevated surface comprising a plurality of perforations extending through the surface to the plurality of channels.

34. The ventilation system of claim 30, wherein the ventilation layer comprises a plurality of interconnected and perforated pipes extending through a porous flooring surface.

35. The ventilation system of claim 34, wherein the porous flooring surface comprises a flexible synthetic material.

36. The ventilation system of claim 35, wherein the porous flooring surface further comprises approximately 50% or more aggregate material.

37. The ventilation system of claim 35, wherein the flexible synthetic material is at least one of urethane, epoxy and polyethelene.

38. The ventilation system of claim 30, wherein the ventilation layer comprises a removable mat.

39. The ventilation system of claim 30, wherein the pump is configured to draw air from the ventilation layer.

40. The ventilation system of claim 30, wherein the pump is configured to force air into the ventilation layer.

41. The ventilation system of claim 30, further comprising a dispersion layer between the ventilation layer and the separation layer.

42. The ventilation system of claim 30, wherein the dispersion layer comprises a small granular material.

43. The ventilation system of claim 30, further comprising a separation layer between the ventilation layer and the animal bedding layer, the separation layer comprising a substantially planar geotextile layer having a plurality of openings therethrough, the openings being smaller than the animal bedding materials but large enough for air to pass through.

44. The ventilation system of claim 43, wherein the separation layer comprises a non-absorptive, non-biodegradable, mesh layer.

45. The ventilation system of claim 43, wherein the separation layer comprises two separation layers having a support layer therebetween, the support layer being substantially rigid and maintaining a space between the separation layers.

46. The ventilation system of claim 30, wherein the granular bedding material comprises granules having a density of between approximately 20 lb/ft³ and approximately 70 lb/ft³.

47. The ventilation system of claim 30, wherein the granular bedding material comprises granules having an LA Abrasion hardness value of less than approximately 40.

48. The ventilation system of claim 30, wherein the granular bedding material comprises granules having an absorption capacity of approximately 0.5 ml/g to approximately 2.5 ml/g.

49. The ventilation system of claim 30, wherein the granular bedding material comprises granules having an absorption capacity of approximately 1.4 ml/g to approximately 1.9 ml/g.

50. The ventilation system of claim 30, wherein the granular bedding material comprises granules having an absorption rate in a 52 mm diameter column of approximately 90 milliliters or more within 10 minutes.

51. The ventilation system of claim 30, wherein the granular bedding material comprises granules having a surface area greater than approximately 2,000,000 ft²/ft³.

52. The ventilation system of claim 30, wherein the granular bedding material comprises granules having a size between approximately 4 mesh to approximately 50 mesh.

53. The ventilation system of claim 30, wherein the granular bedding material comprises granules having a density of between approximately 20 lb/ft³ and approximately 70 lb/ft³, an LA Abrasion hardness value of less than approximately 40, an absorption capacity of approximately 0.5 ml/g to approximately 2.5 ml/g, an absorption rate in a 52 mm diameter column of approximately 90 milliliters or more within 10 minutes, and a surface area greater than approximately 2,000,000 ft²/ft³.

54. The ventilation system of claim 30, further comprising at least two separate ventilation layers for at least two separate animal stalls, the at least two separate ventilation layers each coupled to a controller configured to selectively connect and disconnect the respective ventilation layer to air flow generated through the pump.

55. The ventilation system of claim 30, further comprising a solar collector configured to collect solar energy to operate the pump.

56. The ventilation system of claim 30, wherein the stall is a horse stall and the animal bedding is horse bedding.
